(19) United States
(12) Patent Application Publication
(10) Pub. No.: US 2014/0067562 A1
(43) Pub. Date: Mar. 6, 2014

(54) Digital Hospitality Menu

(71) Applicant: Leon Milton Gravesande, Mount Vernon, NY (US)

(72) Inventor: Leon Milton Gravesande, Mount Vernon, NY (US)

(21) Appl. No.: 14/018,430

(22) Filed: Sep. 5, 2013

Related U.S. Application Data
(60) Provisional application No. 61/697,372, filed on Sep. 6, 2012.

(51) Int. Cl. G06Q 50/12; G06Q 30/06

(52) U.S. Cl. CPC G06Q 50/12; G06Q 30/0641
USPC 705/15

(57) ABSTRACT

A specially designed restaurant menu featuring interactive digital video that showcases pictures of each menu item, along with convenient language selection. Design intent is to provide restaurant patrons with a unique new way in which to choose their meals while also helping them to be better informed about the items ordered.

### CROSS REFERENCE TO RELATED APPLICATIONS

This application claims the benefit of U.S. Provisional Application No. 61/697,372, filed Sep. 6, 2012.

### BACKGROUND OF INVENTION

1. Field of the Invention

This invention relates to the field of handheld restaurant menus. More specifically, this invention is a specially designed restaurant menu featuring interactive digital video that showcases pictures of each menu item, along with convenient language selection. Design intent is to provide restaurant patrons with a new way to choose their meals while also helping them to be better informed about the items ordered.

2. Description of the Related Art

Perhaps the most anticipated moments of the day are meal times, whether easing into a busy day of work or school with leisurely breakfast, enjoying a midday respite at a favorite lunch counter, or recapping the day's adventures over a family dinner. Mealtimes often provide the only opportunities to enjoy the company and camaraderie of friends and love ones in today's fast paced world. Even those who prefer to dine alone look forward to this time so that they can ruminate, relax, and relish their meals in peace and quiet. Regardless of whether meals are taken alone or with a group, eating is a necessity of life that must be met. Even so, people desire to make this necessary experience as pleasurable as possible. For many, basking the ambiance of a cozy restaurant is one of the most delightful ways to enjoy a meal, as one can sit back and let a conscientious wait staff caters to their every need. Yet, even this pleasurable experience can sometimes present drawbacks, especially for first time diners that are not familiar with a restaurant's offerings, with only a paper menu to guide them. Patrons have no choice but to rely on the text description of a food item to let them know what they may be getting. It is not uncommon for a hungry diner to order what he/she thinks is a sizable steak, only to be served a cut barely large enough to satisfy a small child. Additionally, many restaurant menus may be difficult to understand due to language barriers. A couple seeking a romantic dinner in fancy French restaurant would flummoxed by menu choices unless they are fluent in français. Similarly, foreign travelers to America who do not speak English would have a difficult time choosing food described in unfamiliar characters.

Various attempts have been made to solve problems found in the menu art. Among these are found in: U.S. Pub. 2006/0085265 to Timothy Alan Dietz et al; U.S. Pub. 2008/0270244 to Farshad Arasteh; U.S. Pat. No. 7,831,475 to Daniel Joseph Baril et al; U.S. Pat. No. 7,454,370 to Daniel Joseph Baril et al; U.S. Pat. No. 2012/0041847 to Goncalo Jose Cardoso Nunes Caeiro et al; and U.S. Pub. No. 2011/0227853 to Kena Warûngû. This prior art is representative of menus.

None of the above inventions and patents, taken either singly or in combination, is seen to describe the invention as claimed. Thus, a need exists for a reliable digital hospitality menu to avoid the above-mentioned problems.

### SUMMARY OF THE INVENTION

Simply stated, the Digital Hospitality Menu is envisioned as a menu alternative configured as a computer hardware device that contains digital photographs of each menu item, as well as the capability to translate the menu into a variety of languages. Wirelessly operated, the Digital Hospitality Menu would be programmed with a particular establishment for its entire menu offerings, along with a full color photograph of each item's appearance as it is prepared and placed in front of a diner. Each image will be accompanied by a list of the item's ingredients, as well as its nutritional information. This information would be accessed via a liquid crystal display (LCD) touch screen containing a series of operational buttons, which would allow the user to expediently locate breakfast, lunch, dinner and beverage menus, as well as appetizer and dessert selections. Before reaching the menu options on the device, a handy language selector would prompt a user to choose a language best suitable. Further adding to the convenience of this product, the unit's wireless capabilities would allow diners to place orders directly from the Digital Hospitality Menu, sending requests to a main terminal in the restaurant's kitchen or serving area. In addition, users will have the option of paying for their meals right from their Digital Hospitality Menu using credit or debit card. As can be managed, the possibilities inherent in the Digital Hospitality Menu are virtually limitless.

The Digital Hospitality Menu would eliminate any confusion posed by standard text-on-paper restaurant menus. A handheld electronic computer featuring a bevy of interactive options, this product would present an exact image of each and every item offered by the establishment. In this manner, the diners would know exactly what they are receiving when they order a certain food product. As a result, the diner would not be surprised by a portion that is too large or too small, or the addition of an unmentioned ingredient they may not enjoy. Designed for restaurants and resorts, The Digital Hospitality Menu may also find its place in hospitals, nursing homes and other institutional facilities.

### BRIEF DESCRIPTION OF THE DRAWINGS

The figures which accompany the written portion of this specification illustrate embodiments and method(s) of use for the present invention, digital hospitality menu, constructed and operative according to the teachings of the present invention.

FIG. 1 shows a perspective view illustrating a digital hospitality menu in a closed condition according to an embodiment of the present invention.

FIG. 2 is a perspective view illustrating the digital hospitality menu in an open condition (able to be manipulated and read) according to an embodiment of the present invention.

The various embodiments of the present invention will hereinafter be described in conjunction with the appended drawings.

### DETAILED DESCRIPTION

As discussed above, embodiments of the present invention relate to a menu device and more particularly to a digital hospitality menu as used to improve the efficiency and ambiance of reading and ordering from a menu.

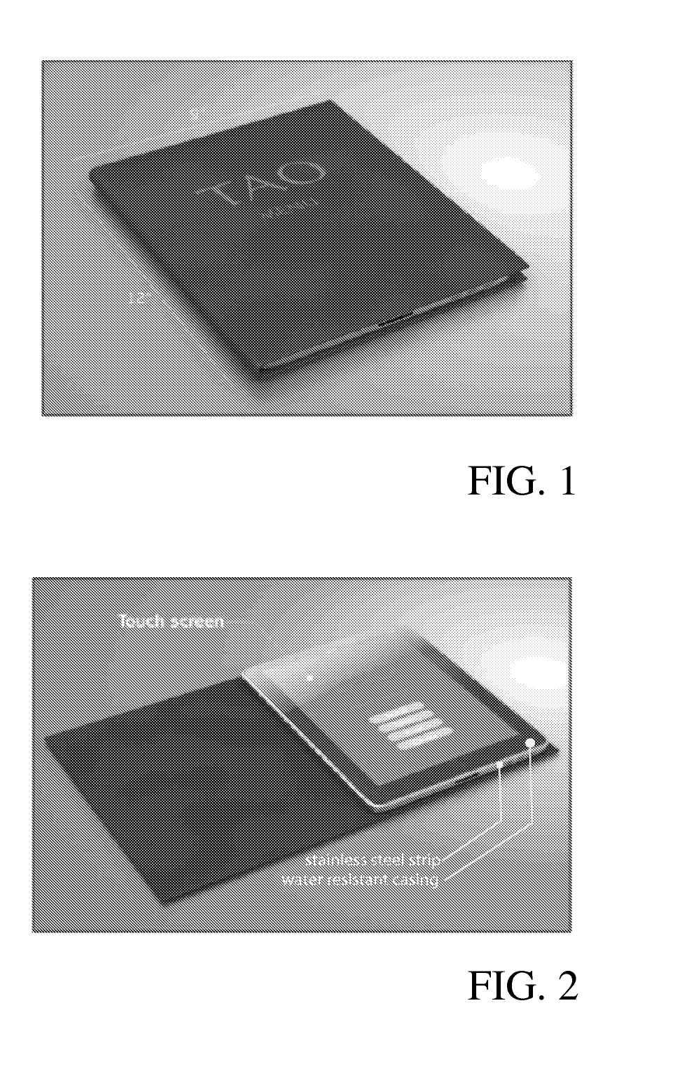

Referring now to the drawings FIGS. 1-2, the digital hospitality menu is a menu alternatively configured as a computer hardware device (tablet or the like) that contains digital photographs of each menu item, as well as the capability to translate the menu into a variety of languages. The unit may comprise essentially a rectangular shape similar in style to a tablet computer, such as the Apple iPad (and may mimic a traditional menu's general shape). Wirelessly operated, the digital hospitality menu may be preprogrammed with a particular establishment's entire menu offerings, along with at least one full-color photograph of each item's appearance as it is when prepared and placed in front of a diner.

Additionally in preferred embodiments each image can be accompanied by a list of the item's ingredients, as well as its nutritional information. The nutritional information may be accessed via a liquid crystal display (LCD) touch screen containing a series of operational buttons, which allow the user to expediently locate breakfast, lunch, and dinner menus, beverage menus, as well as appetizer and dessert selections. Before reaching the menu options on the device, however, a handy language selector may prompt a user to choose whether to display options in English, Spanish, French, Chinese or preferred language. As such, a user need only press the onscreen buttons to access each aspect of the Digital Hospitality Menu.

Further adding to the convenience of this product, the unit's wireless capabilities would allow diners to place orders directly from the digital hospitality menu, sending requests to a main terminal in the restaurant's kitchen and/or serving area. As can be imagined, the possibilities inherent in the Digital Hospitality Menu are virtually limitless and can raise efficiency and sales for restaurants.

There are several significant benefits and advantages associated with this creative product concept. Foremost, the digital hospitality menu may effectively eliminate any confusion posed by standard text-on-paper restaurant menus. A handheld electronic computer featuring a bevy of interactive options, this product is able to present an exact image of each and every item offered by the establishment. In this manner, diners are able to know exactly what they are receiving when they order a certain food product. As a result, the diner would not be surprised by a portion that is too large or too small, or the addition of an unmentioned ingredient they may not enjoy. The restaurant can embellish their items to provide a more desire to the consumer. The device can also be used to advertise (promotions, of products sold and the like).

The incorporation of nutritional facts may prove invaluable to diners on restricted diets, helping them to more easily select healthy foods. Further, the language choices offered by the digital hospitality menu helps ensure that all patrons can read the options available, whether one is an American visiting an authentic Chinese restaurant or a French tourist seated at a New York City steakhouse. Placed into practice by busy restaurant chains, a product such as the digital hospitality menu can handily alleviate excess time spent at tables trying to decode the menu and decide on a meal, as the unit would allow patrons to expediently order beverages, appetizers, entrees, and desserts without having to wait on a server or having to pepper waitstaff with a litany of questions. In this manner, customers may be able to enjoy their meals in a reasonable amount of time without a frustrating wait, additional customers can be served more quickly, and, as a result, the restaurant is able to enjoy increased profits by being able to serve more patrons.

Referring to drawing in FIG. 2, The Digital Hospitality Menu's design features have been made specially to withstand the unexpected mishaps of a restaurant's busy environment. Whether it's a liquid beverage spilling onto the surface or a restaurant patron accidentally dropping the Digital Hospitality Menu on the floor, it's water resistant casing would eliminate any worry of harmful liquids. This said casing will also provide additional protection against any rough handling, dings or dents. The casing will be accompanied by a stainless steel strip which will outline the borders of the casing.

The Digital Hospitality Menu is a cleverly designed product invention that could handily revolutionize the restaurant industry. Cleverly incorporating a menu into a handheld, computerized device, this handy product would certainly alleviate the challenges posed by common menus.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A digital hospitality menu device essentially as described herein which provides restaurant patrons with a new way in which to choose their meals while also helping them to be better informed about the items ordered.

2. A digital hospitality menu device as recited in claim 1, comprising a liquid crystal display touch screen containing a series of operational buttons.

3. A digital hospitality menu device as recited in claim 2, comprising:
a. language selections.
b. menu selections.
c. payment selections.

4. A digital hospitality menu device as recited in claim 3, wherein said menu selections further comprising of a full color photograph or video of each selected items appearance.

5. A digital hospitality menu device as recited in claim 4, further comprising by a list of items ingredients, as well as nutritional information.

6. A digital hospitality menu device as recited in claim 1, further comprising:
a. a water resistant casing.
b. a stainless steel strip which will outline the borders of the casing.
